(19) United States
(12) Patent Application Publication
(10) Pub. No.: US 2023/0218368 A1
(43) Pub. Date: Jul. 13, 2023

(54) Multiple dental tool Kit

(71) Applicant: Boris Kaylakov, rego park, NY (US)

(72) Inventor: Boris Kaylakov, rego park, NY (US)

(73) Assignee: boris kaylakov

(21) Appl. No.: 17/571,494

(22) Filed: Jan. 9, 2022

(51) Int. Cl. A61C 3/16

(52) U.S. Cl. CPC A61C 3/162

(57) ABSTRACT

The present invention is a multiple dental tool apparatus. More specifically, the invention is a crown removal kit designed for use up to four dental tools. The main component of the apparatus is a cylindrical hollow shaft with two male attachments on the sides with one ball centered between attachments. The cylindrical shaft is designed with two different sizes at each end. There are two double ended dental tools replacing four original tools: three Wankeys and one straight crown splitter. Each interchangeable tool is designed as a shaft and in middle of the shaft is a single ball and towards the end each shaft tapers slightly into a smaller diameter and ends in either as one of three keys or straight crown splitter. One double ended bit has two sizes of key crown splitter attached on opposite sides: N1 and N2, smallest and next larger size keys splitter, respectively. The other double ended bit has the largest key splitter, N3 on one side and crown splitter device on the opposite side. Eliminates switching instruments (since 4 in one device, just flip and insert) less procedural time (no need to look for instruments, because no need to switch or search).

### FIELD OF INVENTION

The present invention is a multiple dental tool apparatus. More specifically, the invention is a crown removal kit designed for use up to four dental tools. The main component of the apparatus is a cylindrical hollow shaft with two male attachments on the sides with one ball centered between attachments. The male attachment is designed to pair with the female attachment. The cylindrical shaft is designed with two different sizes at each end. The tools can be switched around with relative ease. In addition, this novel combination device is compact and light weight and in terms of space; take less space in a dental cabinet, on bracket table, and requires less sterilization. Also, the device is an excellent equipment for the-go type of dental appliance for dental practitioners, due to its lower weight and smaller size as compared to original existing dental instruments.

### BACKGROUND

Removal of dental crown is mandatory for many reasons including but not limited to marginal decay, anterior porcelain fracture, poor anterior esthetics (shade of crown is not matching or black line visible along gum line), food impaction (may be due to posterior porcelain fracture), and root canal retreatment (necessity to redo the previous root canal treatment with metal post in canal space, thus requiring removing the crown first). Dental crown is removed when tooth is restorable. In other words, if the tooth is salvageable then dental crown is removed, the defect or problem (like marginal decay-decay around margin of crown) is addressed and then new dental crown is fabricated.

Traditional crown removal devices usually take substantial space on a bracket table during dental procedures for crown removal. Due to that, dental provider lacks a sufficient area for other necessary equipment. Moreover, sometimes dental assistants need to bring a different device during the same procedure and that way crown removal process is delayed. Dental cabinets usually labeled to make easier instrument retrieval. However, if there are multiple instruments for same procedure then dental cabinets can easily fill up and may need additional cabinets for these bulky and multiple devices. Sterilization must be working constantly to sterilize multitude of instruments. Because these bulky instruments take up so much space a need to get duplicate of same device makes it nearly impossible unless office space is increased. Thus, sterilization is working double due to those drawbacks. In addition, since novel devices described below is a combination of other devices it will make crown removal procedure quicker than previously, since no necessity exist to find other instrument or change instrument while working on a patient. That in turn will improve dental practitioner's concentration and therefore the result or outcome of treatment for a patient.

There are three techniques for dental crown removal: conservative, semi-conservative and destructive methods. Conservative method is a process in which the crown is removed without damaging the restoration if possible. With this method, crown can be reused as temporary again, because crown is still intact after removal process. Common device used for this procedure is a sliding hammer. This technique relies on a hook like tip, by engaging the edge of the crown with a shaft and handle, to facilitate loosening of restoration and possible removal. Even though, this device is known to be very useful in terms of removal of temporary crowns, it is very limited on permanent fixed prosthesis. Permanent fixed prosthesis is cemented, and the device can fracture a tooth beneath a crown especially if tooth has bone loss or if it has prior root canal treatment (tooth is more likely to fracture after root canal). Therefore, dental sliding hammer is usually not used for most crown removal purposes.

Semi-conservative method for crown removal is well-known today as Warn key device. This device is very similar to well-known principle described originally by Tylman in 1965. This crown removing device removes crowns in whole. With this method a crown can be reused as temporary later. The device comes in three different elevator-like sizes.

Despite the improvement and advancement of prior devices a lot of dental practitioners rely on the destructive method to remove crowns, because destructive method usually is safer in removal of crown without fracturing of the tooth structure and more likely being successful in fixed prosthesis removal. Destructive method (“destroying crown”) involves sectioning of crown in half with bur making cut buccal-lingually to separate the two pieces and retrieve them individually. The device commonly used for this procedure is called a crown splitter. It has a mini-elevator handle and notched tip to break the seal of cement, thus separating sectioned crown from tooth structure. Despite being more reliable and successful in terms of outcome for crown removal without damaging tooth structure; it is quite time consuming as compared to other methods. Also, this destructive method as the name implies makes it impossible to reuse the sectioned crown as temporary, because it was cut in half. Therefore, there is a need for a dental crown removal apparatus and methods of use that allow a user to easily and effectively remove a crown from a patient's mouth. More specifically, a need for a dental crown removal apparatus and methods that there is no need to switch devices or to look for other instruments since they are already attached to the device. Thus, dental provider will be able to flip and insert the dental tools like a multi-bit screwdriver set. Moreover, there is a need for a dental crown removal apparatus and methods of use that allows a user to grasp the handle in a screwdriver type apparatus to impart sufficient pressure and force against a crown to remove that crown from a patient's tooth, the handle provides a sufficient gripping means for a practitioner to handle the same and provide the sufficient leverage.

### SUMMARY OF THE INVENTION

The present invention relates to a dental crown removal apparatus and methods. Specifically, the present invention provides a dental crown removal apparatus for easily and efficiently removing a dental crown. Methods of using the same are further provided. The dental apparatus comprises a cylindrical hollow shaft, three keys splitter, and straight crown splitter and handle. The cylindrical hollow shaft is designed with two male attachments on the sides and one ball in the center. Additionally, a hollow opening of the shaft has internal hexagonal shape. The male attachments of the hollow shaft fit into female receptacles on handle, similar like a key fitting keyhole. Both ends of the cylindrical shaft are two different sizes. One end of the shaft has slightly smaller diameter then the other end. The handle is composed of hollow tunnel with two rectangular grooves or female receptacles. There are two double ended dental tools replacing four original tools: three Wankeys and one straight crown splitter. Each interchangeable tool is designed as a shaft and in middle of the shaft is a single ball and towards the end each shaft tapers slightly into a smaller diameter and ends in either as one of three keys or straight crown splitter. One double ended bit has two sizes of key crown splitter attached on opposite sides: N1 and N2, smallest and next larger size keys splitter; respectively. The other double ended bit has the largest key splitter, N3 on one side and crown splitter device on the opposite side. Shaft of each double ended bit has external hexagon that fit into internal hexagon on hollow shaft. The device holds four dental tools simultaneously because of the difference in sizes, the tools can be switched around with relative ease. Two double ended tools replace three Wamkey elevator sizes for semi conservative crown removal purposes and one straight crown splitter for destructive method. That will make process of crown removal quicker; because there is no need to find other instrument just flip and insert. This method saves time; improves practitioner concentration, eliminates lengthy hours of sterilization and need for spacious cabinets to maintain all instruments. Thus, sterilize one instrument, need cabinet space for one instrument instead of four devices, no need to look for other instrument, or switch instruments during procedure. When practitioner searches for other instruments, usually patient thinks something is wrong, or something is not going right. The device is easy to assemble. Place dental key splitter N1 and N2 keys splitters so that the double ended bit is inserted into shaft with N2 inside and N1 outside that hollow shaft. Place the other keys splitter so that straight crown splitter inserted inside while N3; the largest wamkey key splitter is outside the shaft. Then place the combined product of two bits and hollow shaft into handle so that N1 is outside, while N3 is inside the handle. Some of the primary advantages of the dental kit according to the present invention is that it contains all the instruments, implements necessary to perform a crown removal operation. The kit is, furthermore, compact in construction and can be easily transported from office to office, Thus, the kit functions not only as a storage tray but also as a delivery tray. Moreover, the various instruments and implements are segregated from each other in an organized fashion so that the proper instruments, implements or medicaments can be rapidly located and removed during the crown removal operation. Eliminates lengthy search for instruments (since 4 in one device). Eliminates switching instruments (since 4 in one device, just flip and insert).

### BRIEF DESCRIPTION OF THE DRAWING

A better understanding of the present invention will be had upon reference of the following detailed description when read in conjunction with the accompanying drawing.

FIG. 1A, is a perspective view of a preferred embodiment of the dental kit of the present invention.

FIG. 1 B. is a perspective view of a preferred embodiment of the dental kit of the present invention.

FIG. 1C. is a frontal view of a part of the dental kit.

FIG. 1D. is a frontal view of a part of the dental kit.

FIG. 1E. is a sectional view of a part of the dental kit.

FIG. 2 is a view of a part of the dental kit, or inside view of the handle

FIG. 3 is a view of a part of the dental kit, hollow cylinder and its view from inside

FIG. 4. is a sectional or magnified view of a part of the dental kit.

### DETAILED DESCRIPTION OF A PREFERRED EMBODIMENT OF THE PRESENT INVENTION

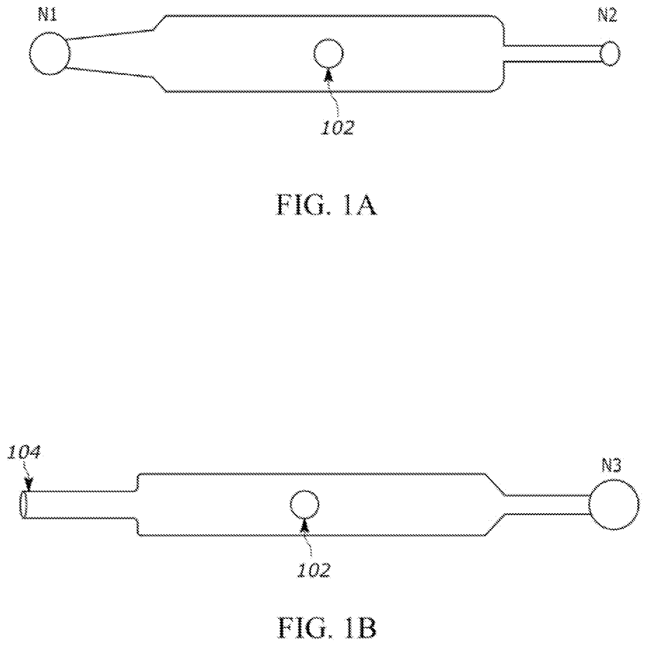

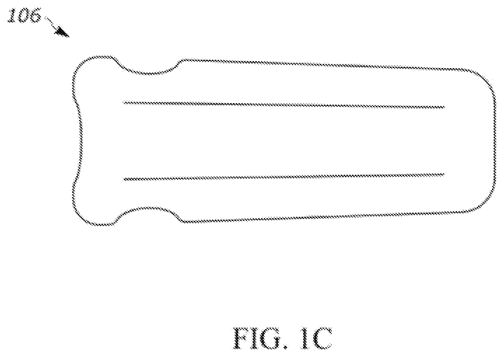

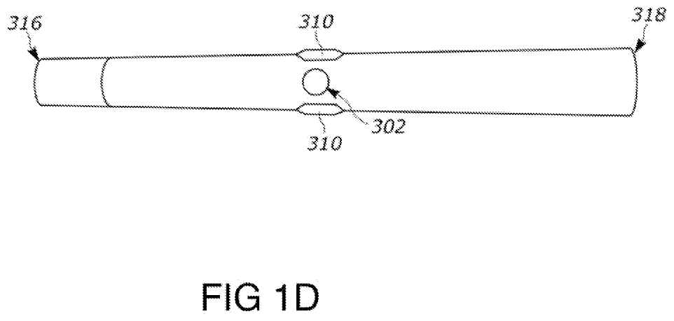

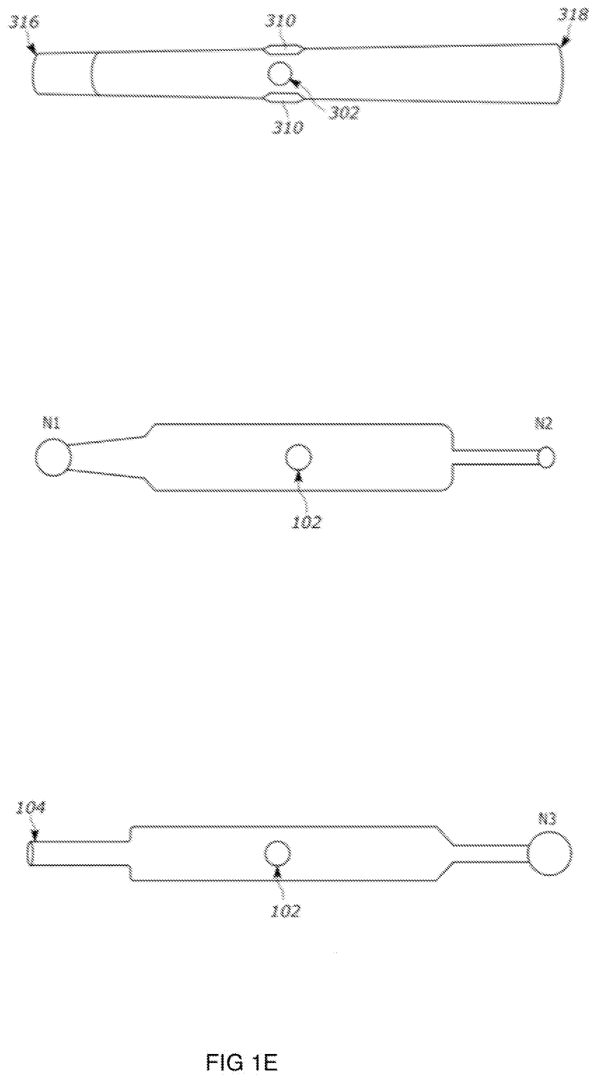

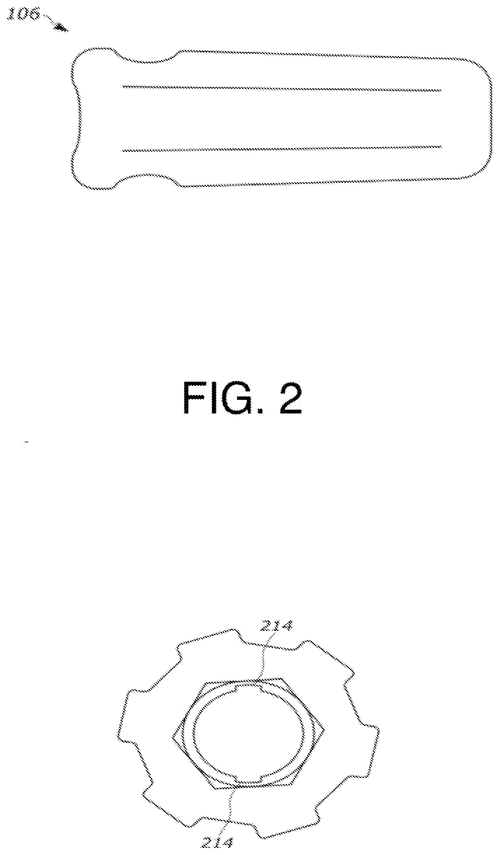

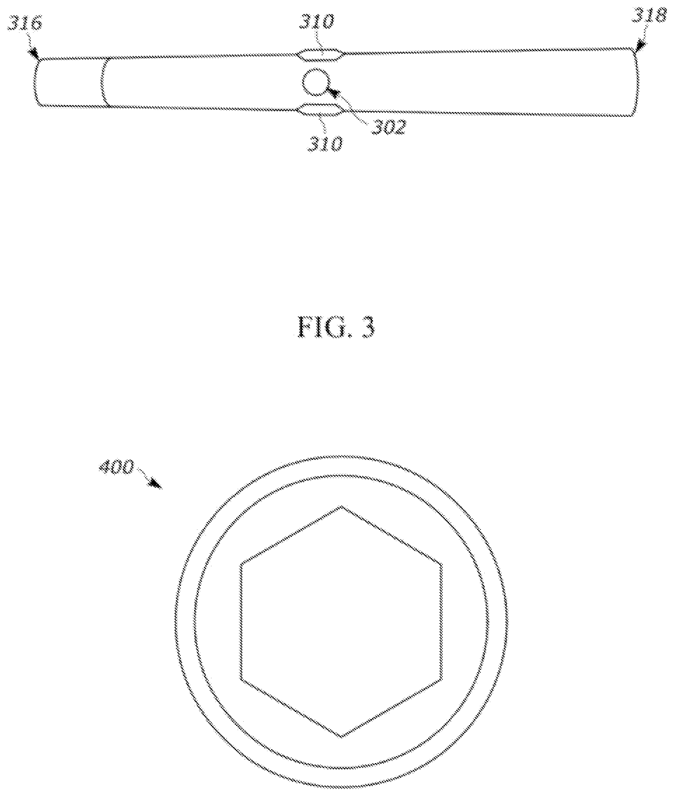

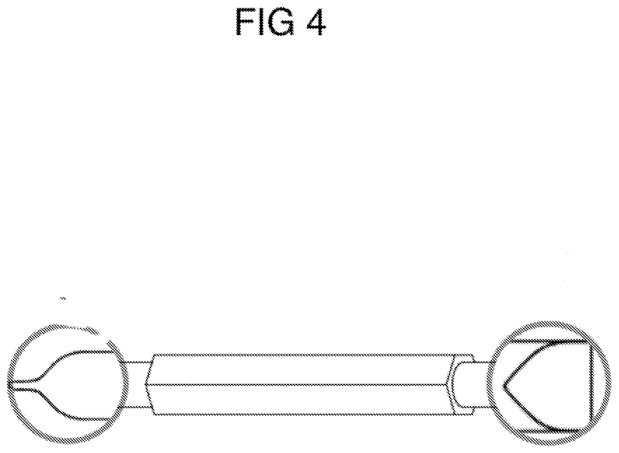

With reference to FIGS. 1A and 1B, a preferred embodiment of the dental kit according to the present invention shown as N1, N2, N3, 102 and 104. N1, N2 and N3 are key splitters that function like a wamkey keys but the tip of a wamkey is cylinder-like with oval shape area that has a flat surface and rounded oval on periphery. In this novel the device shape is rounded oval on periphery but instead of flat oval shape it has more conical and tapered end. The reason for this modification; it will create more surface area contact between key splitter and crown. Due to its conical nature the device is more ergonomic and produces a quicker result for crown removal. The modification allows less fracture risk on a tooth structure since all surfaces engaging tooth are rounded. Also, an original Wamkey key metal shaft connecting handle is very narrow at the tip and can break during rotation. The design of this invention has thicker cylinder bar that connects the tip to the common shaft located in middle securely and is difficult to break during rotation. N1 is the smallest key splitter, and N2 next larger size. N3 is the largest key splitter and 104 is a crown splitter device on the opposite side. Shaft of each double ended bit has external hexagon that fit into internal hexagon on hollow shaft. 102 are the balls to connect the key splitters to the shaft. FIG. 1C 106 is the handle for the device. FIG. 1D is the main housing component of the apparatus is a cylindrical hollow shaft with two male attachments, 110 on the sides and single ball. 102 between those attachments. The male attachment is designed to pair with the female attachment on handle. FIG. 1E The cylindrical shaft is designed with two different sizes at each end and the different sizes allow for simultaneous use of all 4 devices just need to flip and insert. N1 is the smallest key splitter, and N2 next larger size. N3 is the largest key splitter and 104 is a crown splitter device on the opposite side. Shaft of each double ended bit has external hexagon that fit into internal hexagon on hollow shaft FIG. 2 The handle is composed of hollow tunnel with two rectangular grooves or female receptacles FIG. 3 310 are the male attachments, 302 is the ball and 318 is the wider diameter and 316 is smaller diameter of the shaft, FIG. 3 Shaft of each double ended bit has external hexagon that fit into internal hexagon on hollow shaft. FIG. 4 There are two double ended bits. Each interchangeable bit has shaft and in middle of shaft there is a single ball. Toward end each shaft tapers slightly into smaller diameter and ends in either as one of 3 key splitter or straight crown splitter. One double ended bit has two sizes of key splitters attached on opposite sides: N1 and N2, smallest and next larger size Wamkey keys, respectively. The other double ended bit has largest Wamkey key, N3 on one side and crown splitter device on the opposite side.

It should be noted that the descriptions are just for illustrative purposes only, and it is to be understood that changes and variations may be made without departing from the spirit or scope of the following claims.

1-6. (canceled)

7: A dental crown removal device comprising: a Handle, a double ended cylindrical hollow shaft and two double ended bits.

8: A dental crown removal device as in claim seven, wherein said handle; which is single ended comprises internal female attachment and two female receptacles that can receive and secure either ends of the double ended hollow shaft.

9: A dental crown removal device as in claim seven, wherein said; double ended cylindrical hollow shaft comprises two male attachments and releasing ball that fit into female internal attachment of the said handle.

10: A dental crown removal device as in claim seven, the double ended cylindrical hollow shaft comprises an internal attachment end on each side and can receive and secure either one of the two double ended bits.
